(19) United States
(12) Patent Application Publication
(10) Pub. No.: US 2006/0238801 A1
(43) Pub. Date: Oct. 26, 2006

(54) SYSTEM AND METHOD FOR TRANSMITTING DATA QUICKLY BETWEEN A CLIENT AND A SERVER

(76) Inventors: Hoi Chan, Shenzhen (CN); Peng Zeng, Shenzhen (CN); Gang Liu, Shenzhen (CN); Feng-Hua Luo, Shenzhen (CN); Yu-Hao Wu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,649

(22) Filed: Apr. 17, 2006

(30) Foreign Application Priority Data
Apr. 22, 2005 (CN) 200510034366.1

(51) Int. Cl. G06F 3/12

(52) U.S. Cl. 358/1.15; 358/442

(57) ABSTRACT

The present invention provides a system for transmitting data quickly between a client and a server. The system includes at least one server (2) and a plurality of clients (1). The server provides an administration interface to the client, and includes: an inputting module (20) for inputting file directory paths via the administration interface; a judging module (21) for determining whether a reference document that corresponds to a source document in the client exists on the server, and for identifying a difference between the updated source document and the reference document according to verifications; a copying module (22) for copying the reference document to the server; and a transmitting module (23) for transmitting the difference, and for updating the copied document according to the difference. A related method is also disclosed.

### DESCRIPTION

1. Field of the Invention

The present invention relates to a system and method for transmitting data quickly between a client and a server.

2. Description of Related Art

The continued growth and expansion of the Internet, especially in regards to what has become to known as the World Wide Web, which allows information on the internet to be transmitted through a user-friendly graphical interface. The World Wide Web is a collection of client/server systems, which corresponds to millions of connected computers, and is basically a vast collection of interconnected document files.

Typically, on the Internet, during data transmission between a client and a server, data passes through a number of Route Nodes before arriving at a destination. However, it is hard to avoid data loss during the data transmission process. Any data loss would influence validity of the data, especially when network transmission is busy because of network instability. Various data transfer speeds of networks may also bring many inconveniences to the users. Reducing quantity of the network transmission and increasing the speed of the network transmission are helpful to reduce the congestion of the network transmissions and to enhance response speed between the client/server.

What is needed, therefore, is a system and method that can transmit data between a client/server more convenient and quickly by identifying a difference between an updated source document and a reference document. If only the difference is transmitted to the server or client, the quantity of network transmissions can be reduced and data can be transmitted more quickly. Moreover, the user may also query statuses of the network transmission.

### SUMMARY OF INVENTION

A system for transmitting data quickly between a client and a server is provided. The system includes a server and a client. The server provides an administration interface to the client, and includes: an inputting module for inputting file directory paths via the administration interface; a judging module for determining whether a reference document that corresponds to a source document in the client exists on the server, and for identifying a difference between the updated source document and the reference document according to verifications; a copying module for copying the reference document to the server; and a transmitting module for transmitting the difference and for updating the copied document according to the difference.

Furthermore, a method for transmitting data quickly from a client to a server is provided. The method includes the steps of: updating a source document in the client; logging into an administration interface provided by the server; inputting a destination path into the server and selecting a version number; creating a new storage path in the server according to the destination path and the version number; inputting a search path to find a reference document in the server, where the reference document corresponds to the source document; determining whether the reference document exists in the server according to the search path; copying the reference document to the newly created storage path if such a reference document exists in the server; identifying a difference between the updated source document and the reference document; and transmitting the difference to the server and updating the copied document in the server according to the difference.

Moreover, another method for transmitting data quickly from a server to a client is provided. The method includes the steps of: updating a source document in the server; logging into an administration interface; creating a new storage path; inputting a search path to find a reference document in the client, where the reference document corresponds to the source document; determining whether the reference document exists in the client according to the search path; copying the reference document to the newly created storage path if such a reference document exists in the client; identifying a difference between the updated source document and the reference document; and transmitting the difference to the client and updating the copied document in the client according to the difference.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration of a system for transmitting data quickly between a client and a server in accordance with a preferred embodiment;

FIG. 2 is a schematic diagram of main software function modules of a server of FIG. 1; and

FIG. 3 is a flowchart of a method for transmitting data quickly from a client to a server in accordance with a preferred embodiment of the present invention.

### DETAILED DESCRIPTION

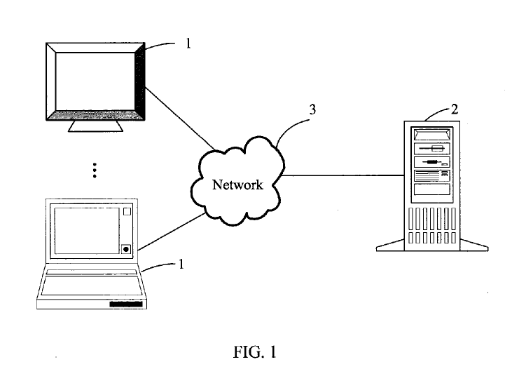

FIG. 1 is a schematic diagram of hardware configuration of a system for transmitting data quickly between a client and a server (hereinafter, “the system”) in accordance with a preferred embodiment of the present invention. The system includes a plurality of clients 1 (only two shown) and at least one server 2. The server 2 communicates with the clients 1 via a network 3. Each of the plurality of clients 1 is used for providing an interactive interface enabling users to perform needed operations. For example, a user may update a source document in the client 1 and transmit the updated source document to the server 2 by using the interactive interface.

The server 2 is used for providing an administration interface to the clients 1, and for providing version numbers for the user to select one version number for the updated source document before the user transmits the updated source document from the client 1 to the server 2. The version number is used for distinguishing between the source document and its updated version in the client 1. Generally, the version number selected by the user is larger than the most updated version number of a reference document in the server 2, where the reference document corresponds to the source document in the client 1. If the selected version number is equal to or less than the most updated version number of the reference document, the server 2 prompts the user to confirm the selected version number as a double-checking means, and the user may change the selected version number according to the prompt or keep the selected version number. The network 3 may be an intranet, the Internet, or any other type of communication link.

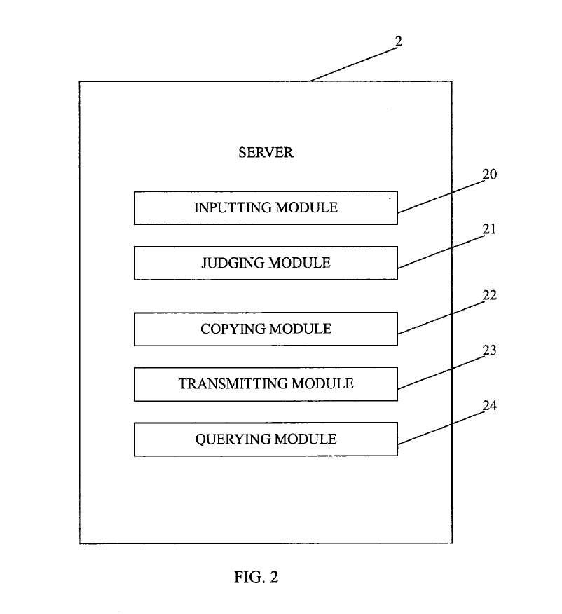

FIG. 2 is a schematic diagram of main software function modules of the server 2. The server 2 provides an administration interface to all clients 1, and includes an inputting module 20, a judging module 21, a copying module 22, a transmitting module 23, and a querying module 24.

The inputting module 20 is used for inputting different kinds of file directory paths via the administration interface, such as storage paths of source documents in the client 1, the search paths for searching the server 2 for reference documents corresponding to the source documents, and destination paths in the server 2 when the user transmits the updated source documents from the client 1 to the server 2, and so on. The inputting module 20 is also used for providing an index of all the paths set forth above. The user inputs the paths manually or selects a suitable path according to the index provided. When the user transmits an updated source document from the client 1 to the server 2, the user needs to input a destination path into the server 2, and the server 2 provides a number of version numbers for the user to select from for the updated source document. The inputting module 20 is further used for creating a new storage path in the server 2 according to the destination path and the selected version number, for example, the inputting module 20 inputs the destination path as “C:/Documents/Desktop/” and the user selects the version number as 2.0, then the inputting module 20 creates a new storage path as “C:/Documents/Desktop/2.0”. The newly created storage path is used for storing a copied document of the reference document.

The judging module 21 is used for determining whether the reference document corresponding to the source document exists in the server 2 according to the search path inputted by the user. If the reference document exists in the server 2, the judging module 21 is further used for identifying a difference between the updated source document and the reference document with identification methods such as parity checking, cyclic redundancy check (CRC), and checksum verification etc. For example, if the user adds or edits contents in the source document, the judging module 21 would identify the modified contents according to parity checking and cyclic redundancy check (CRC). As another example, if the user deletes any contents in the source document, the judging module 21 would identify the different values of the updated source document and the reference document by checksum verification.

The copying module 22 is used for copying the reference document to the newly created storage path in the server 2. The copied document would have the same filename as the reference document. The transmitting module 23 is used for transmitting the difference between the updated source document and the reference document to the server 2, and for updating the copied document according to the difference. For example, as described above, after the judging module 21 identifies the modified contents of the updated source document, the transmitting module 23 only transmits the modified contents and updates the copied document according to the modified contents. As another example, if the judging module 21 identifies that the values of the updated source document and the reference document are different, the transmitting module 23 transmits the value of the updated source document, and updates the copied document according to the value of the updated source document.

Otherwise, if the reference document dose not exists in the server 2, the transmitting module 23 transmits and stores the whole updated source document from the client 1 to the server 2.

The querying module 24 is used for querying statuses of transmission, and for determining whether the transmission is successful according to the statuses.

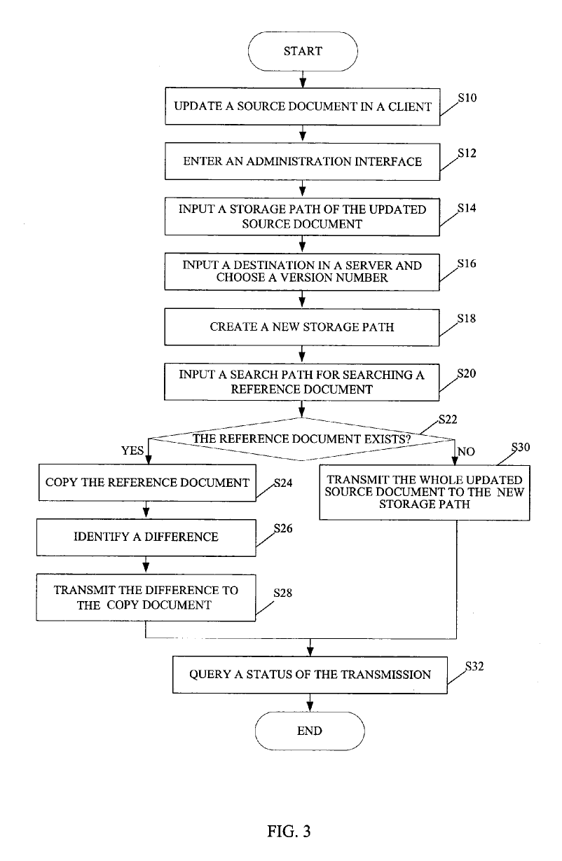

FIG. 3 is a flowchart of a method for transmitting data quickly from the client 1 to the server 2. In step S10, the user updates a source document in the client 1. In step S12, the user logins to an administration interface provided by the server 2. In step S14, the inputting module 20 inputs or selects a suitable storage path for the updated source document in the client 1 via the administration interface according to an index provided by the server 2. In step S16, the inputting module 20 inputs a destination path into the server 2 and the user selects a version number provided by the server 2 where the selected version number corresponds to the updated source document.

In step S18, the inputting module 20 creates a new storage path in the server 2 according to the destination path and the selected version number. In step S20, the inputting module 20 inputs a search path into the server 2 to find a reference document corresponding to the source document. In step S22, the judging module determines whether the reference document exists in the server 2 according to the search path.

If such a reference document exists in the server 2, in step 24, the copy module 22 copies the reference document to the newly created storage path. In step S26, the judging module 21 identifies a difference between the updated source document and the reference document. In step S28, the transmitting module 23 transmits the difference to the server 2 and updates the copied document according to the difference in the server 2. In step S32, the user queries statuses of transmission in order to determine whether the transmission is successful via the querying module 24.

If no reference document exists in the server 2, in step S30, the transmitting module 23 transmits the whole updated source document to the newly created storage path.

The above procedure is also applicable for transmitting data quickly from a server to a client according to user demands, except for a different step: step S16. In the procedure of transmitting data quickly from a server to a client, the inputting module 20 does not input the destination path, and the server 2 selects the suitable version number automatically according to the version number of the reference document in the client 1, the inputting module 20 creates the new storage path according to the storage path of the reference document in the client 1 and the automatic selected version number.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for transmitting data quickly between a client and a server, the system comprising a server and a client, the server providing an administration interface to the client, the server comprising:
an inputting module for inputting file directory paths via the administration interface;
a judging module for determining whether a reference document that corresponds to a source document in the client exists on the server, and for identifying a difference between the updated source document and the reference document according to verifications;
a copying module for copying the reference document to the server; and
a transmitting module for transmitting the difference, and for updating the copied document according to the difference.

2. The system as claimed in claim 1, wherein the file directory paths comprise storage paths, search paths and destination paths.

3. The system as claimed in claim 1, wherein the server further comprises a querying module for querying statuses of transmission, and for determining whether the transmission is successful according to the statuses.

4. The system as claimed in claim 1, wherein the inputting module is further used for creating a new storage path for storing the copied document.

5. The system as claimed in claim 1, wherein the inputting module is further used for providing an index of a plurality of file directory paths in the server.

6. The system as claimed in claim 1, wherein the transmitting module is further used for transmitting and storing the whole updated source document.

7. A method for transmitting data quickly from a client to a server, the method comprising the steps of:
updating a source document in the client;
logging into an administration interface provided by the server;
inputting a destination path into the server and selecting a version number;
creating a new storage path in the server according to the destination path and the version number;
inputting a search path to find a reference document in the server, where the reference document corresponds to the source document;
determining whether the reference document exists in the server according to the search path;
copying the reference document to the newly created storage path if such a reference document exists in the server;
identifying a difference between the updated source document and the reference document; and
transmitting the difference to the server and updating the copied document in the server according to the difference.

8. The method according to claim 7, wherein the determining step comprises the step of transmitting and storing the whole updated source document to the newly created storage path if no reference document exists in the server.

9. The method according to claim 8, further comprising the step of querying statuses of the transmission.

10. The method according to claim 7, further comprising the step of querying statuses of the transmission.

11. A method for transmitting data quickly from a server to a client, the method comprising the steps of:
updating a source document in the server;
logging into an administration interface;
creating a new storage path;
inputting a search path to find a reference document in the client, where the reference document corresponds to the source document;
determining whether the reference document exists in the client according to the search path;
copying the reference document to the newly created storage path if such a reference document exists in the client;
identifying a difference between the updated source document and the reference document; and
transmitting the difference to the client and updating the copied document in the client according to the difference.

12. The method according to claim 11, wherein the determining step comprises the step of transmitting and storing the whole updated source document to the created new storage path if no reference document exists in the server.

13. The method according to claim 12, further comprising the step of querying statuses of the transmission.

14. The method according to claim 11, further comprising the step of querying statuses of the transmission.
